(19) United States
(12) Patent Application Publication
(10) Pub. No.: US 2018/0141220 A1
(43) Pub. Date: May 24, 2018

(54) ROBOT DEVICE COMPRISING A DRIVEN UNIT, AND APPLICATION METHOD

(71) Applicant: WAELISCHMILLER ENGINEERING GMBH, Markdorf (DE)

(72) Inventors: Richard MAIER, Bermatingen (DE); Peter Maier, Oberteuringen (DE); Enver Huber, Ravensburg (DE)

(73) Assignee: WAELISCHMILLER ENGINEERING GMBH, Markdorf (DE)

(21) Appl. No.: 15/865,557

(22) Filed: Jan. 9, 2018

Related U.S. Application Data
(63) Continuation of application No. PCT/EP2016/066082, filed on Jul. 7, 2016.

(30) Foreign Application Priority Data
Jul. 10, 2015 (DE) 10 2015 111 170.5

(51) Int. Cl. B25J 19/00; C09D 5/24; B05D 1/02; B05D 1/18; B25J 11/00

(52) U.S. Cl. CPC B25J 19/0075; C09D 5/24; B25J 18/025; B05D 1/18; B25J 11/0085; B05D 1/02

(57) ABSTRACT

A robot device having a driven unit is proposed, wherein the driven unit is conceived for approaching surfaces. The driven unit according to the present invention is covered with a protective layer from a coating material which is electrically conductive and has a thickness of at least 4 millimeters.

### CROSS REFERENCE TO RELATED APPLICATIONS

This application is a continuation of International Application No. PCT/EP2016/066082 filed Jul. 7, 2016, which designated the United States, and claims the benefit under 35 USC § 119(a)-(d) of German Application No. 10 2015 111 170.5 filed Jul. 10, 2015, the entireties of which are incorporated herein by reference.

### FIELD OF THE INVENTION

The present invention relates to a robot device comprising a driven unit for approaching surfaces covered with a protective layer from a coating material which is electrically conductive, and application method.

### BACKGROUND OF THE INVENTION

Technical apparatuses such as robot devices having a driven unit which is conceived for approaching surfaces, in particular, having a movable driven robotic arm, are known. Such robot devices are typically controlled in a computer-aided manner. Robot devices of this type are used for carrying out automated procedures such as, for example, high-precision production steps or jobs in an environment that is critical for humans.

However, there are still fields of application in which the use of robot devices is indeed desirable but in which to date the necessary preconditions for the use of a robot have not yet been successfully achieved.

### SUMMARY OF THE INVENTION

It is therefore an object of the present invention to achieve for the devices discussed at the outset the preconditions for the use of a robot which to date have not been able to be met in a manner suitable for practical use, in particular in order to advantageously enable operations by robot devices in the case of critical environmental conditions, such as, for example, operations in explosion-endangered regions. Various parameters or guidelines, respectively, which are relevant to the field of explosion protection apply worldwide, these in Europe being the so-called ATEX guidelines.

The present invention proceeds from a robot device having a driven unit which is conceived for approaching surfaces, in particular, having a movable robotic arm. The robot device can in particular have a stationary part and a driven unit that is configured as a movable robotic arm, wherein the movable robotic arm is connected to the stationary part at a positionally fixed connection point. The robotic arm is preferably adjustable full-length, and in spatial terms is alignable in an almost arbitrary manner. For example, all the surfaces in the interior of a container can thus be approached by the unit without any person having to be inside the container, for example. A mobile and/or flight-capable robot device is also conceivable.

The core of the present invention lies in that the driven unit is covered with a protective layer from a coating material which is electrically conductive and has a thickness of at least 4 millimeters, in particular, at least 6 millimeters, to approx. 20 millimeters. The thickness of the protective layer is measured perpendicularly to an external surface of the driven unit to which the protective layer is adjacent. A safe operation in an explosion-endangered environment, or in an ATEX environment, respectively, is thus advantageously enabled in a manner that is reliable and suitable for practical use. By way of the present invention, it is excluded with sufficient reliability that conditions which could lead to an explosion arise by virtue of the presence or of the use, respectively, of the driven unit in the use of the driven unit in an explosion-endangered environment.

Apart from a robotic functionality, the robot device according to the present invention is distinguished by the potential of movement in an explosion-endangered region.

In particular, procedures or situations, respectively, that trigger explosions, such as corresponding interactions of the driven unit that are mechanically caused with the environment or with neighboring objects, respectively, can be avoided by way of the assembly according to the present invention. By virtue of the design embodiment according to the present invention, it is possible in an absolutely reliable manner that even an impact on the driven unit, in particular, an impact by a pointed object on the unit from the outside, cannot lead to an explosion and/or that any relative movements of the driven unit that entail any contact in relation to neighboring objects or faces, respectively, trigger such an explosion. After all, the creation of sparks, static charging or a separation of a charge, respectively, and/or high temperatures, are avoided according to the present invention or are reliably kept at an entirely non-critical level.

Static charging of the driven unit is, in particular, reliably excluded by way of the electrical dissipation capability of the protective layer.

The minimum thickness of the protective layer of at least 4 mm, in particular at least 6 mm, to approx. 20 mm, even in the case of friction-based procedures between the unit with objects in the environment, which in practical terms can never be excluded, and an impact by a pointed object leads to a spark not being able to be created in the environment of the driven unit. Moreover, in the case of friction between the protective layer and counter portions, no explosion-critical temperature level can be created by friction heat. Apart from the thickness of the protective layer, other properties of the protective layer are also to be preferably observed or to be predefined to this end, respectively.

The protective layer can be single-layered or multi-layered.

A robotic arm, or a driven unit, respectively, that is coated in a protective manner according to the present invention is thus capable of being reliably used in an explosion-endangered environment.

The driven unit, or the external side thereof, respectively, comprises, in particular, a housing on which the protective layer is externally present, for example, is applied as a covering. The protective layer advantageously is directly or immediately adjacent to the external surface of the external side. The protective layer with the external side of the driven unit advantageously forms a materially integral connection.

A mobile unit and/or a flight-capable unit having a driven operating unit are/is also conceivable as a robot device having a driven unit, wherein the mobile unit is, in particular, activatable and controllable in a remote-controlled manner from a remote region.

The robot device according to the present invention can be advantageously employed in containers having a comparatively large internal volume, wherein the internal volume is filled with gas or is mixed with air, respectively, and typically represents with high probability an explosion-endangered environment, or an explosive gas mixture, respectively. Such containers are, for example, containers in chemical or petrochemical plants, respectively, or in the petrochemical industry, respectively, which for internal cleaning, or for cleaning internal faces of the container, respectively, have to be taken out of regular use. To this end, extremely complex preparatory and post-operative measures have been necessary to date, those measures thus additionally entailing, in particular, extensive downtimes. Apart from the high costs for materials and the deployment of personnel in the context of the cleaning, further costs, or lost revenue, respectively, by virtue of the downtimes of the container per se and, in particular, of all devices interacting with the latter are to be added.

In practice to date, tragic accidents having extremely negative consequences, or causing fatalities respectively, are not excluded, wherein a frequent cause of death when working in containers is death by asphyxiation. This is because respective containers are typically purged with nitrogen in order to avoid explosions in the container.

By way of the protective layer according to the present invention, a critical situation in terms of an explosion-endangered environment is reliably avoided even in the case of unforeseen events in the container, for example, by a physical or mechanical interaction, respectively, of the driven unit according to the present invention, such as the robot device crashing into an object or sliding along neighboring surfaces such as, for example, a container wall or the surfaces that are to be approached by the container, this without a robot device that is configured according to the present invention potentially leading to an explosion and thus in some circumstances to victims and economic catastrophes.

By way of the protective layer according to the present invention, a creation of sparks, a critical increase in temperature, a separation of a charge or static charging of surfaces, respectively, are avoided and thus all preconditions for a gas explosion are reliably excluded. The proposed protective layer acts in an equally reliable manner in all potential exemplary cases and is without exception safe in terms of an explosion-triggering state.

It is furthermore advantageous for the protective layer to be composed of a coating material, wherein the coating material in the application to the driven unit is liquid, preferably free-flowing. The coating material is moreover capable of curing, but has no tendency whatsoever to fracture, or is preferably elastic, respectively. By way of a coating material that is liquid when applied, a raft of different methods and devices can be utilized for advantageously applying the protective layer to the surface of the driven unit. In particular, the protective layer is capable of being applied in a homogenous or uniform manner, respectively, and without gaps, at the pre-definable desired thickness. Defects in the protective layer on account of a missing or inadequately configured protective layer on the driven unit are advantageously excluded. In particular, automated coating methods by way of which the coating material that in the initial state is liquid or free-flowing, respectively, and is capable of being sprayed or spread, respectively, can be applied in a reproducible and defined manner can be preferably employed.

Spreading, spraying, atomizing, casting, or dipping methods are to be considered, in particular, as suitable coating or application methods. The free-flowing or pasty coating material, respectively, herein is applied effectively to the, in particular, metallic surface of the driven unit.

An application of the liquid coating material by rotary coating is also conceivable.

As an alternative to a coating material that in the initial state is liquid, other states are also conceivable such as, for example, the application of a coating material that in the initial state is solid such as, for example, planar or pulverulent.

According to a further advantageous variant of the present invention, the applied protective layer in a state of mechanical stress forms an, in particular, closed annular force externally about the driven unit. The annular force manifests that the driven unit by the protective layer is surrounded externally under contact pressure in continuously encompassing or a circumferentially closed manner. For example, the protective layer in the manner of a shrink film that acts in a temperature-dependent manner, in an initial state can be applied over the external side of the driven unit, and subsequently, for example, by an increase in temperature, can be subjected to a non-reversible shrinking or compressing process, respectively. In particular, by way of the completion of the shrinking process, a contact-pressure effect becomes effective in such a manner that the protective layer in an advantageously permanent pre-tensioned state bears firmly on the exterior of the driven unit. The protective layer such as, for example, shrink film, bears on the external side of the driven unit in direct, tight, and fixedly connected manner.

It is furthermore advantageous for the protective layer to be of a multi-layered construction. As an alternative to a single coating, a multi-layered construction of the protective layer is advantageously possible. A coating which in relation to other protective layer is optionally of higher quality can thus be achieved by way of the protective layer. A protective layer of a multi-layered construction can advantageously and optionally be provided from a plurality of identical or dissimilar individual layers that are fixedly interconnected or continuous. For example, a multi-layered construction can be composed of layers which are individually applied in liquid form, for example. A continuous protective layer which is composed of a material that is applied so as to be wound on top of itself is also conceivable. For example, a continuous film that is capable of being wound can be applied so as to be wrapped on the driven unit. Alternatively, a film that in the manner of a multi-layered composite is applied such as, for example, adhesively bonded, in multiple layers to the external side of the driven unit is implementable.

It is moreover advantageous for the protective layer to have a dissipation capability with a specific resistance between 10⁴ Ωm and 10⁹ Ωm. This relates to 23° C. and a relative air humidity of 50%.

This correlation is defined, for example, in TRBS (Technische Regeln für Betriebssicherheit) ([Technical rules for operational safety] 2153 paragraph 12). Accordingly, a respective object or a device has a surface resistance between 10⁴ Ωm and 10⁹ Ωm, measured at 23° C. and 50% relative air humidity, or between 10⁴ Ωm and 10¹¹ Ωm, measured at 23° C. and 30% relative air humidity.

This leads to a static charge, or a separation of a charge, by way of the driven unit being avoided, for example, when a contacting relative movement takes place between the driven unit or the protective layer thereof, respectively, and the environment, for example, on account of friction-related procedures on a counter portion. A creation of sparks that are potentially triggered on account thereof, is reliably avoided by virtue of the electrical dissipation capability. Charge carriers, or charges, respectively, on or in the protective layer, respectively, by virtue of the electrical dissipation capability of the protective layer are dissipated in particular to the regions of the driven unit to which the protective layer of the driven unit is applied. The respective regions, such as the housing of the driven unit, are typically electrically conductive per se and from a metallic material, for example, and preferably electrically earthed.

The protective layer according to the present invention in terms of the dissipation capability thereof can be characterized by a predefined electrical conductivity, for example.

It is also advantageous for the material of the protective layer to be based on a thermoplastic material. A thermoplastic material is a thermoplastic plastics material which as a standard material is available in a multiplicity of different material properties and which in terms of processing is advantageous. A thermoplastic material is readily mixable with a multiplicity of other materials and is processable by proven methods and devices. The material of the protective layer can also be based on a mixture of different thermoplastic materials and optionally also comprise proportions of other plastics materials. A composite material based on a thermoplastic material is also conceivable as a protective layer.

Advantageously, a substrate of the driven unit that is to be protected is coatable or coverable, respectively, in a continuous manner with the thermoplastic material. The protective layer in the region of expansion joints or of separation regions, respectively, between continuous segments of, for example, a driven movable robotic arm is indeed not connected, but the complete substrate that is to be protected is completely covered by the protective layer. Preconditions for the functioning of joints or for adjusting the length of the robotic arm in the region of the separation regions are implemented by way of the separation regions. Robotic arms from a multiplicity of arm segments that interact in an articulated or otherwise movable manner can thus be advantageously provided with the protective layer in the transition regions, this representing a particular challenge.

It is furthermore advantageous for the protective layer to include an electrically dissipation-capable component which is present so as to be distributed in a base material of the protective layer, wherein a dissipation capability of the protection layer is pre-definable. The desired dissipation capability of the thermoplastic material is thus implemented. The base material of the protective layer is preferably made from the thermoplastic plastics material, wherein a comparatively minor quantity of the component that provides the electrical dissipation capability of the completed protective layer in the mixture is present so as to be distributed in the thermoplastic plastics material. The other material such as, for example, an ingredient added to the thermoplastic material, accounts for approx. 1 to approx. 25% by weight of the protective layer, for example.

In particular, the protective layer is largely composed of a base matrix from a thermoplastic material having an electrically dissipation-capable component that is present in the latter so as to be uniformly distributed therein. In particular, particles and/or fibrous materials, preferably carbon material such as graphite, for example, are to be considered as added ingredients. The added component can advantageously be added to the granulated thermoplastic material and herein be mixed with the thermoplastic material prior to the thermoplastic material being melted.

It is also advantageous for the protective layer to be connected to a surface of the driven unit in a materially integral manner. The protective layer is advantageously applied directly and to the full area, or tightly, respectively, of the respective surface of the driven unit. For an advantageous configuration of the protective layer, defects without any connection between the protective layer and the respective surface of the driven unit are excluded. Linking the protective layer to the surface is performed in particular by adhesive effects and/or a form-fit.

In order for the protective layer to be connected to the driven unit, self-adhesive properties of the protective layer are advantageously used, or the self-adhesive capability of a liquid adhesive such as a liquid thermoplastic material is advantageously used for connecting the surfaces of the protective layer and of the driven unit. Alternatively or additionally, adhesives can be used for configuring an adhesive connection between the protective layer and the respective surface of the driven unit. The adhesive per se advantageously has the material properties of the protective layer.

A further advantageous modification of the present invention is distinguished in that the protective layer is applied to the driven unit in such a manner that no cavities, or just non-critical cavities, respectively, are present between the protective layer and the surface of the unit. Cavities which are closed or open in relation to an environment of the unit are to be excluded. It is thus reliably excluded that a potentially explosive gas mixture can accumulate in the region of the protective layer or on the surface of the coated driven unit, respectively. A potential risk of explosion on account of an explosive gas mixture that has accumulated in the region of the protective layer is thus counteracted.

It is furthermore advantageous for the protective layer on the driven unit to be present in such a manner that a critical relative movement between the protective layer and the driven unit is precluded. In particular, it is thus advantageously reliably avoided that a relevant increase in temperature of surfaces of the robot device takes place on account of friction effects. On account thereof, an otherwise possible explosion of an explosive medium that is potentially enclosed in the robot device, the explosion being caused by an increase in temperature by virtue of the friction effects, can be excluded.

For example, a tubular or sleeve-type sheathing of the driven unit that is movable in relation to the driven unit is thus unsuitable since a relative movement is possible between the sheathing and the surface of the driven unit, which can lead to a static charge or to a separation of a charge, respectively.

An advantageous embodiment of the present invention is characterized in that the protective layer does not have any at least substantial cavity. It is advantageously achieved here too that no explosive gas mixture can accumulate or be present within the protective layer, respectively.

In particular, no closed cavity or closed hollow in which an explosive mixture can potentially accumulate or be formed is provided within the protective layer. A foam material, likewise a foamed protective layer or chamber-type construction of a protective layer having cavities or hollow chambers, respectively, is thus typically unsuitable as a protective layer.

It is moreover advantageous for the robot device to be designed so as to be movable conjointly with the driven unit in order for a movement in an explosion-endangered region to be enabled. For example, the robot device or the robot, respectively, can be represented by a driven vehicle. The robot device can be, for example, a remote-controlled robot or a remote-controlled vehicle for operating on interior walls of a container, wherein the remote-controlled vehicle, for example, can be drivable so as to adhere to faces that are aligned horizontally, vertically, and/or in other spatial directions in a container.

It is finally advantageous for the driven unit to comprise a driven robotic arm which has a plurality of segments for a variably adjustable length and/or alignment of the robotic arm. In particular, tubular portions of dissimilar diameters that can be displaced in one another or be connected in a telescopic manner, respectively, that are hollow on the inside and thus have a space for devices for driving the driven unit or the segments and/or a tool on the robotic arm, respectively, or on a front end of a front most segment, respectively, can be present here. These segments according to the present invention are covered with the protective layer as has been explained above.

The present invention also relates to a robot device having a driven unit, which is conceived for approaching surfaces, in particular, having a movable robotic arm, wherein the driven unit is covered with a protective layer from a coating material, wherein the coating material has a melting temperature of 135° C. or less than 135° C.

Explosion-protection regulations which are relevant to the robot device for use in an explosion-endangered environment, for example, based on the so-called ATEX guidelines, are advantageously met by way of the protective layer proposed. In particular, the triggering of an explosion is excluded in the case of a driven unit of the robot device that is coated with such a coating material. In terms of the risk of an explosion, friction-related procedures in which an increase in temperature of the participating friction partners takes place as a consequence are particularly critical.

For example, in the case of friction contact between the robot device, or of the protective layer, respectively, and the environment, or a respective counter face, respectively, this taking place as a relative movement which is possible in practice, the environmental temperature which is always below the melting temperature of the coating material, an increase in temperature, proceeding from a non-critical temperature of the protective layer, will take place on account of the friction energy up to at maximum the melting temperature of the coating material. As the melting temperature is reached, the rubbing or external part of the protective layer, respectively, that is in frictional contact with the counter face, is liquefied. On account of the liquefaction of the respective part of the coating material, the latter is released from the remaining part, or the further inward part, respectively, of the protective layer, the latter remaining below the melting temperature and therefore remaining in the solid-state. By virtue of the relative movement, the liquefied part of the protective layer is released from the location of friction, friction influences thus no longer acting on this part. Consequently, the temperature of the liquefied coating material cannot rise any further, or the coating material cools below the melting temperature, respectively, or solidifies again, respectively. In the case of friction effects on the protective layer, a temperature of more than 135° C. cannot arise at any time. However, the occurrence of a maximum temperature of 135° C. is entirely non-critical from the point of view of any relevance to an explosion, or in an explosive environment, respectively. The triggering of an explosion is thus reliably avoided by way of the protective layer according to the present invention.

There is no risk of an explosion even in the case of an impact of a pointed or blunt object on the protective layer from the outside, wherein the object penetrates down to the surface of the driven unit that is typically composed of a metallic material. After all, in the case of an elastic and plastic deformation of the coating material at the location of the impact, the protective layer sheathes the invading part of the object such that there is no space for an explosive mixture. Moreover, a creation and propagation of sparks is not possible. A critical increase in temperature, or a creation of sparks, respectively, is thus excluded in the case of an impact.

In scenarios which are relevant to practical conditions, the triggering of an explosion is reliably avoided by virtue of the protective layer according to the present invention.

In the case of one advantageous modification of a robot device according to the present invention, a protective layer based on a thermoplastic plastics material applied to regions of a driven unit of a robot device is applied to the respective regions of the driven unit in the liquid state by heating the thermoplastic material. The protective layer preferably has a dissipation capability with a specific resistance between 10⁴ Ωm and 10⁹ Ωm. The minimum thickness of the protective layer is four millimeters. The requirements set for a robotic device for a use according to ATEX are thus met, wherein the production of the protective layer is possible in an advantageous manner.

A further substantial aspect of the present invention finally lies in a method for applying a protective layer based on a thermoplastic plastics material to regions of a driven unit of a robot device, wherein the protective layer is applied to the respective regions of the driven unit in the liquid state by heating the thermoplastic material, and wherein the protective layer has a dissipation capability with a specific resistance between 10⁴ Ωm and 10⁹ Ωm.

By way of the protective layer based on a thermoplastic plastics material, the protective layer by heating the, for example, granulated, thermoplastic material can be liquefied and be applied to the respective regions of the driven unit in the liquid state. By subsequent cooling or solidifying, respectively, or curing, respectively, the thermoplastic material, a closed layer-type covering of the driven unit is formed by way of the thermoplastic protective layer. The cooled down thermoplastic material here in is preferably connected to the respective surface regions of the driven unit in a materially integral manner. For a desired adhesion of the thermoplastic material on the driven unit with the desired high bonding forces, care has to be taken that the respective surface regions of the driven unit are prepared in a corresponding manner, or are optionally pretreated, for example.

The production of a robot device according to the present invention is thus possible in an advantageous manner.

Alternatively, a robot device having a driven unit which is conceived for approaching surfaces, in particular, having a movable robotic arm, wherein the driven unit is provided with a protective layer which comprises a porous layer which is fillable with a liquid is conceivable. Operating in an explosion-endangered environment can be advantageously enabled by way of the liquid-filled porous layer. The liquid is preferably water. The porous layer can be filled with the liquid prior to an operational use in the explosive zone. The porous layer can be advantageously humidified during the operational use, preferably continuously. It is thus achieved that the porous layer is filled with the liquid to a sufficient degree at all times.

The porous layer is preferably configured in such a manner that a capillary effect is achieved by way of the open pores. The filling of the pores, or a replenishing flow of liquid into the pores, respectively, can thus be performed in an advantageous manner.

A further alternative robot device is distinguished in that the driven unit is provided with a protective layer which comprises a hollow element that is fillable with gas and/or liquid, the hollow element being enclosed by an external skin. The gas is a non-explosive gas. The liquid is correspondingly a non-explosive liquid. The external skin is preferably gas-tight and liquid-tight. Moreover, the external skin is, in particular, variable in terms of shape, for example, elastic. The hollow element which in commercial operation is closed is preferably formed in the manner of a balloon.

Finally, another alternative robot device has a driven unit having a protective layer which comprises shell elements from a plastics material that are adapted to the driven unit and are capable of being applied to the driven unit. The plastics material is preferably a thermoplastic material. The adapted shell parts in the applied states bear on the external surfaces of the driven unit. Operating in an explosion-endangered environment without any risks is likewise made possible. The, for example, thermoplastic shell parts can be applied to the driven unit in a multiplicity of ways, for example, by screwing, adhesive bonding, and or by a form-fit.

In the case of all aforementioned types of coating, either according to the present invention or as an alternative thereto, that relate to the covering coating material, the porous layer that is filled with a liquid, the protective layer which comprises a hollow element that is fillable with the gas and/or liquid, and the protective layer which comprises shell elements from a plastics material that are adapted to the driven unit, have an adequate protection against an explosion. The protection is, in particular, reliably guaranteed in the case of the driven unit scraping along a surface and in the case of an impact on the driven unit having the coating. Moreover, all types of coatings have a defined high dissipation capability such as mentioned above, in particular with a specific resistance between 10⁴ Ωm and 10⁹ Ωm.

The protective effect in the case of an impact on the porous layer and on the closed balloon are of such a manner that a spark is extinguished. In the case of the adapted shell elements, the respective point is enclosed and the spark cannot escape, as is the case also with the closed protective layer made of a coating material having a pre-definable thickness.

When scraping along surfaces, a spark is extinguished in the case of the porous layer and of the closed balloon. In the case of the adapted shell elements and of the closed protective layer, the elements and said layer melt when scraping, preventing the creation of an ignition condition.

### BRIEF DESCRIPTION OF THE DRAWINGS

Further features and advantages of the present invention are explained in more detail by means of exemplary embodiments that are illustrated in a highly schematic manner.

FIG. 1 shows a highly schematic fragment of a robot device according to the present invention;

FIG. 2 schematically shows a front portion of a driven unit of an alternative robot device according to the present invention; and

FIG. 3 shows a fragment of part of the robot device according to FIG. 2 in the section.

### DETAILED DESCRIPTION OF THE INVENTION

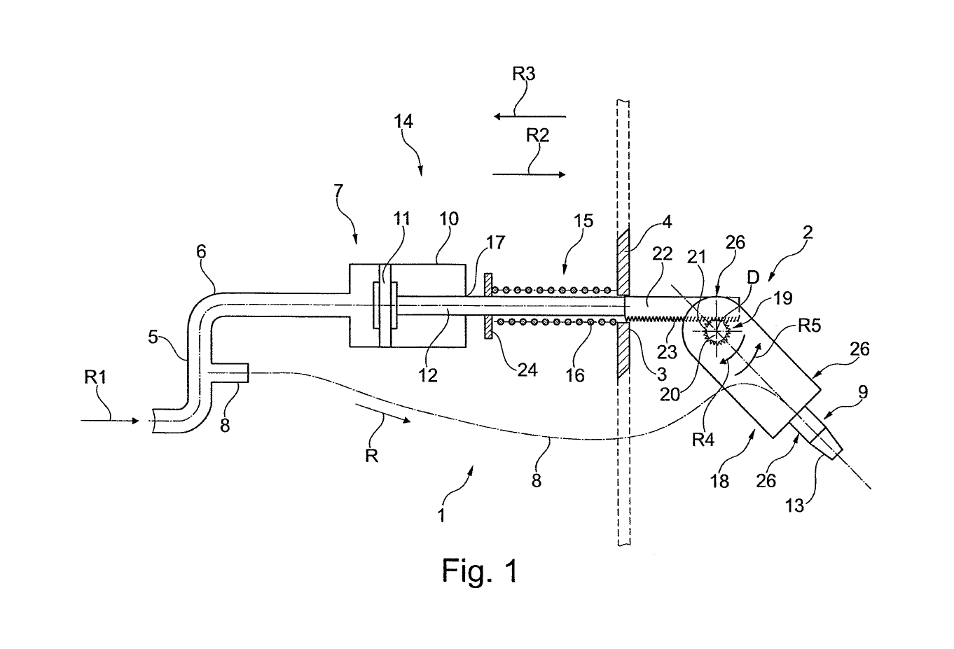

FIG. 1 in a highly schematic manner shows a functional unit which is configured as a controlled positionable nozzle system 1 which is designed, for example, to be assembled on an arm (not illustrated) for cleaning internal faces of tanks. The nozzle system 1 comprises a controllable or pivotable, respectively, nozzle 2 by way of which a pressurized liquid such as, for example, water, is applied to the internal faces.

The nozzle system 1 on the supply side, outside a housing 4 having an opening 3, has a water infeed line 5 for an overall water inlet which is impinged with a controllable overall water pressure, the water infeed line 5 being supplied from the outside with water or with a cleaning or auxiliary agent, respectively, according to the inflow direction R1. The periphery of the opening 3 represents a counter-pressure face for supporting a spring 16 which will be described further below. The water infeed line 5 branches to form an inlet 6 to a hydraulic unit 7, and an inlet 8 to a water nozzle unit 9. The connection to the water nozzle unit 9 in FIG. 1, with the water flowing in according to the water nozzle infeed direction R by way of the inlet 8, is not illustrated in a realistic manner but for improved clarity is indicated in dashed lines.

The hydraulic unit 7 comprises a cylinder 10 and a piston 11 which in the former is guided in a tight and reversible manner according to R2 and R3, respectively, a piston rod 12 engaging with the piston 11 in a fixedly connected manner. The piston rod 12 is guided in a liquid-tight manner through a passage 17 in the cylinder 10 and from the cylinder 10 extends outward up to or through the opening 3. The water pressure p1 of the water inlet in the inlet 6 bears on the water side of the piston 11 of the hydraulic unit 7. The hydraulic units serves to control the direction of nozzle 2. The nozzle 2 in an exemplary manner is configured as a water nozzle 13 such as, for example, a high-pressure nozzle for cleaning surfaces.

On account of the movement of the piston 11 conjointly with the piston rod 12, a linear movement 14 of the piston 11 conjointly with the piston rod 12 is provided in the direction R2 and counter thereto in the direction R3. A spring unit 15 having the spring 16, for example a coiled spring, generates a counterforce on the piston rod 12 having the piston 11, the counterforce acting counter to a force on the piston 11 that is generated by the hydraulic unit 7 impinged by the water pressure. The spring 16 is received so as to be pre-tensioned between the detent face of the housing 4 of the functional unit and a counter plate 24, wherein the counter plate 24 is fixedly connected to the piston rod 12.

A rotary joint 19 is provided in order for the linear movement 14 of the piston rod 12 to be converted to a rotating movement of an operating element 18 about the rotation axis D, wherein the water nozzle 13 is present on the operating element 18.

The rotary joint 19 acts between a sprocket 20 that is received in a positionally fixed manner on the operating element 18, and a rack 22 having a toothed portion 23 which meshes with a sprocket portion 21 of the sprocket 20.

The functional principle for the spatial alignment, or for the controlled and directed movement of the water nozzle 13, respectively, is explained hereunder. The water nozzle 13 herein is controlled so as to depend on the overall water pressure in the water infeed line 5.

When the overall water pressure in the water infeed line 5 rises, a higher compressive force on the piston 11 is generated on the water side in the hydraulic unit 7, wherein the piston 11 conjointly with the piston rod 12 moves in the direction R2, the operating element 18 conjointly with the water nozzle 13 thus rotating in the clockwise direction, in the direction R4, about the rotation axis D. In the movement of the piston 11 conjointly with the piston rod 12 in the direction R2 the counterforce acts by way of the compressed spring 16.

When the overall water pressure in the water infeed line 5 drops, a lower compressive force on the piston 11 is generated on the water side in the hydraulic unit 7, wherein the piston 11 conjointly with the piston rod 12 under the spring force of the compressed spring 16 moves in the direction R3, such that the operating element 18 conjointly with the water nozzle 13 rotates in the anti-clockwise direction, in the direction R5, about the rotation axis D.

In the case of a constant overall water pressure in the water infeed line 5, the piston 11 conjointly with the piston rod 12 moves until an equilibrium of forces between the force by virtue of the action of the spring 16 and the water pressure force on the piston 11 by virtue of the water pressure prevails, the piston 11 then remaining in its position. The operating element 18, or the water nozzle 13, respectively, stops or does not rotate any further, respectively, under the associated rotation angle of the operating element 18 or of the water nozzle 13, respectively around the rotation axis D.

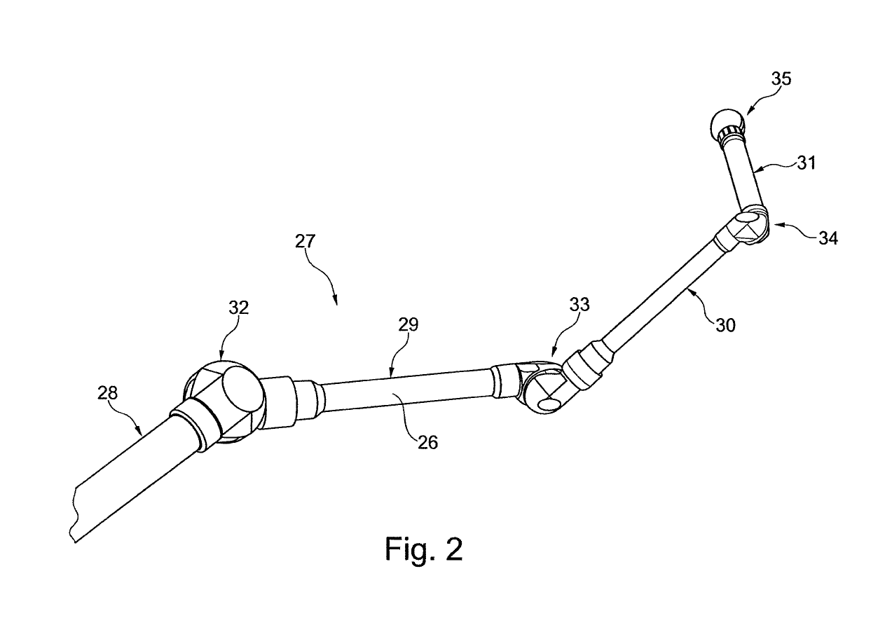

FIG. 2 in a schematically illustrated manner shows a front portion of a driven unit of a robot device according to the invention. The driven unit, in an exemplary manner, is configured as a robotic arm 27 having a plurality of arm portions that are connected in an articulated manner. The plurality of arm portions comprise an arm portion 28 that is illustrated in fragments in FIG. 2, and further arm portions 29 to 31. The part of the robotic arm 27 shown relates to the front part of the arm portion 28 which by way of a joint 32 is connected in an articulated manner to the arm portion 29 that is adjacent to the arm portion 28. The arm portion 29 in turn by way of a joint 33 is connected in an articulated manner to the arm portion 30. Finally, the arm portion 30 by way of a joint 34 is connected to the end-side arm portion 31 in an articulated manner. A functional unit 35, having, for example, an inspection camera (not illustrated in more detail) is present at the free end of the arm portion 31, in order to be able to inspect an interior space of a container, for example.

All external surfaces of the robotic arm 27 are provided with a protective layer 26 according to the present invention.

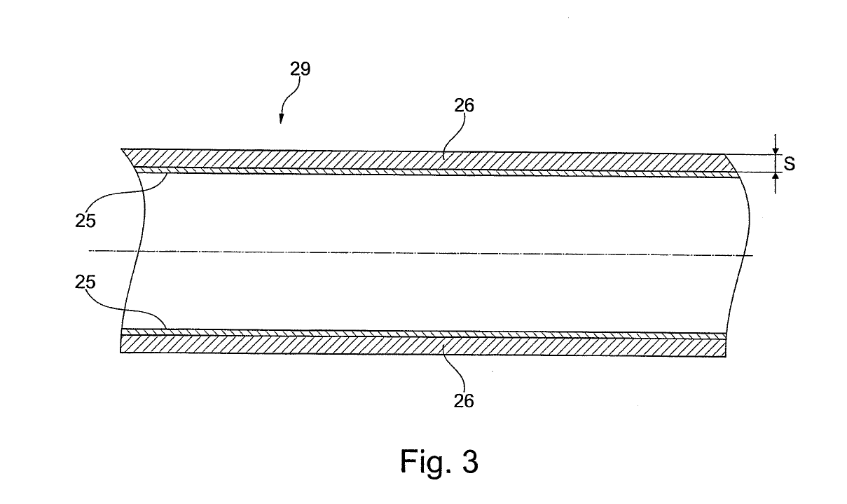

FIG. 3 shows a portion, or an exemplary geometry, respectively, of the arm portion 29 which is sectioned in the longitudinal direction. Accordingly, the arm portion 29 is designed as a profile having a profiled wall 25. The profile can be tubular, for example. The profile wall 25 is formed from a metallic material, for example, such as a steel material, for example. The protective layer 26 is present on the external side of the profiled wall 25 so as to bear thereon in a continuously tight manner and is fixedly connected to the profiled wall 25. The layer thickness S of the protective layer 26, which is preferably at least 4 millimeters to approx. 20 millimeters, here preferably has a thickness of approx. 6 millimeters and in terms of the design embodiment is preferably configured so as to be consistent across all external surfaces of the arm portion 29. The surfaces of the arm portions 28, 30, and 31, and of the joints 32 to 34, and of the functional unit 35, are coated in a corresponding manner.

### LIST OF REFERENCE SIGNS

1 Nozzle system
2 Nozzle
3 Opening
4 Housing
5 Water infeed line
6 Inlet
7 Hydraulic unit
8 Inlet
9 Water nozzle unit
10 Cylinder
11 Piston
12 Piston rod
13 Water nozzle
14 Linear movement
15 Spring unit
16 Spring
17 Passage
18 Operating element
19 Rotary joint
20 Sprocket
21 Sprocket portion
22 Rack
23 Toothed portion
24 Counter plate
25 Profiled wall
26 Protective layer
27 Robotic arm
28-31 Arm portion
32-34 Joint
35 Functional unit

1. A robot device having a driven unit adaptable to approach a surface, wherein the driven unit is covered with a protective layer made from a coating material that is electrically conductive and has a thickness of 4 mm-20 mm.

2. The robot device as claimed in claim 1, wherein the protective layer is composed of a coating material that is applied to the driven unit as a liquid.

3. The robot device as claimed in claim 1, wherein the protective layer is in a state of mechanical stress that forms a closed annular force externally about the driven unit.

4. The robot device as claimed in claim 1, wherein the protective layer is of a multi-layered construction.

5. The robot device as claimed in claim 1, wherein the protective layer has a dissipation capability with a specific resistance between 10⁴ Ωm and 10⁹ Ωm.

6. The robot device as claimed in claim 1, wherein the material of the protective layer comprises a thermoplastic material.

7. The robot device as claimed in claim 1, wherein the protective layer has an electrically dissipation-capable component which is present so as to be distributed in a base material of the protective layer, and wherein a dissipation capability of the protective layer is pre-definable.

8. The robot device as claimed in claim 1, wherein the protective layer is connected to a surface of the driven unit in a materially integral manner.

9. The robot device as claimed in claim 1, wherein the protective layer is applied to the driven unit in such a manner that no cavities or just non-critical cavities are present between the protective layer and the surface of the driven unit.

10. The robot device as claimed in claim 1, wherein the protective layer is present on the driven unit to preclude critical relative movement between the protective layer and the driven unit.

11. The robot device as claimed in claim 1, wherein the protective layer does not have any substantial cavity.

12. The robot device as claimed in claim 1, wherein the robot device is designed so as to be movable conjointly with the driven unit, in order to enable a movement in an explosion-endangered region.

13. The robot device as claimed in claim 1, wherein the driven unit comprises a driven robotic arm which has a plurality of segments for a variably adjustable length and/or alignment of the robotic arm.

14. A robot device having a driven unit adaptable to approach a surface, wherein the driven unit is covered with a protective layer formed from a coating material having a melting temperature of 135° C. or less.

15. A robot device comprising a protective layer based on a thermoplastic plastics material that is applied to regions of a driven unit of the robot device in the liquid state by heating the thermoplastic material.

16. A method for applying a protective layer based on a thermoplastic plastics material to regions of a driven unit of a robot device, wherein the protective layer is applied to the respective regions of the driven unit in the liquid state by heating the thermoplastic material, and wherein the protective layer has a dissipation capability with a specific resistance between 10⁴ Ωm and 10⁹ Ωm.

17. The robot device as claimed in claim 1, wherein the coating material has a thickness of 6 mm-20 mm.

18. The robot device as claimed in claim 2, wherein the liquid is free-flowing.
